(19) United States
(12) Patent Application Publication
(10) Pub. No.: US 2020/0231856 A1
(43) Pub. Date: Jul. 23, 2020

(54) THERMAL STORAGE MATERIAL, COLD INSULATION CONTAINER, AND REFRIGERATOR

(71) Applicant: SHARP KABUSHIKI KAISHA, Sakai City, Osaka (JP)

(72) Inventors: SATORU MOTONAMI, Sakai City, Osaka (JP); YUKA UTSUMI, Sakai City, Osaka (JP); KYOHEI SEZUKURI, Sakai City, Osaka (JP); MASAKAZU KAMURA, Sakai City, Osaka (JP); HWISIM HWANG, Sakai City, Osaka (JP)

(21) Appl. No.: 16/630,164

(22) PCT Filed: Jul. 9, 2018
(86) PCT No.: PCT/JP2018/025865

§ 371 Date: Jan. 10, 2020

(30) Foreign Application Priority Data
Jul. 13, 2017 (JP) 2017-136791

(51) Int. Cl. C09K 5/06; F25D 3/02

(52) U.S. Cl. CPC C09K 5/063; F25D 3/02

(57) ABSTRACT

A thermal storage material changes phase at a prescribed temperature. The thermal storage material includes water, a base compound including a quaternary ammonium salt that forms a semi-clathrate hydrate; and potassium hydrogen carbonate. The potassium hydrogen carbonate is saturated at an onset temperature of solidification.

### TECHNICAL FIELD

The present invention, in some aspects thereof, relates to thermal storage materials that change phase at a prescribed temperature and also to cold insulation containers and refrigerators using such a material.

The present application hereby claims priority to Japanese Patent Application, Tokugan, No. 2017-136791 filed in Japan on Jul. 13, 2017, the entire contents of which are incorporated herein by reference.

### BACKGROUND ART

Clathrate hydrates, semi-clathrate hydrates in particular, crystallize when an aqueous solution of their base compound is cooled to or below a temperature at which a hydrate is formed. Crystals will store thermal energy that may be utilized as latent heat. The clathrate hydrate has therefore been used as a latent thermal storage material or as a component of such a material.

Substances worth a mention here are hydrates of quaternary ammonium salts, which are typical examples of semi-clathrate hydrates encaging a non-gaseous species as a guest compound. These hydrates form under normal pressure, give out a large amount of thermal energy (amount of stored heat) upon crystallization, and are, unlike paraffin, non-flammable. Therefore, hydrates of quaternary ammonium salts are easy to handle and for this reason attracting attention as a replacement of ice thermal storage tanks in air conditioning systems for buildings.

Among these materials, the semi-clathrate hydrate encaging tetra-n-butylammonium bromide or tri-n-butyl-n-pentylammonium bromide as a guest has latent heat the thermal energy of which becomes available for use at temperatures higher than the temperature at which the thermal energy of the latent heat of ice becomes available for use. Therefore, the semi-clathrate hydrate has been increasingly used in thermal storage tanks and heat transport media that are more efficient than ice thermal storage tanks.

However, the temperature at which the semi-clathrate hydrate forms, that is, the solidification temperature at which the semi-clathrate hydrate crystallizes, transitioning from the liquid phase to the solid phase, is significantly influenced by the supercooling phenomenon of water. Therefore, the difference between the solidification temperature and the melting temperature at which the thermal energy of latent heat becomes available for use is so large that it is in some cases difficult to handle the semi-clathrate hydrate. Minerals and other supercooling inhibitors have been used to reduce the influence of the supercooling.

Patent Literature 1 discloses a technique of introducing a particular additive to an aqueous solution of raw materials. Disodium hydrogen phosphate and a thickening agent are added to tetrabutylammonium bromide (TBAB) (33 wt %) in this technique.

Patent Literature 2 discloses a thermal storage material capable of cooling by exploiting latent heat at two different phase transition temperatures. In this thermal storage material, TBAB is used as a material that changes phase at a relatively high temperature, and potassium hydrogen carbonate is used as a material that changes phase at a relatively low temperature.

### CITATION LIST

### Patent Literature

Patent Literature 1: Japanese Unexamined Patent Application Publication, Tokukai, No. 2013-060603

Patent Literature 2: PCT International Application Publication No. WO2016/002596

### SUMMARY OF INVENTION

### Technical Problem

As described above, semi-clathrate hydrates of quaternary ammonium salts, especially those of TBAB, are efficient cold storage materials with a melting temperature at approximately 10° C. Their melting points are lowered generally by reducing the concentration of an aqueous TBAB solution. Reducing the TBAB concentration, however, results in a higher water concentration. Water, which freezes at 0° C., is difficult to freeze in a common refrigerator. Desirable materials should have a relatively low melting point and still freeze in a refrigerator.

Patent Literature 1 falls short of providing a material that stably freezes in a common refrigerator. The materials disclosed in Patent Literature 1 have a relatively high melting point of approximately 12° C. Additionally, the amount of latent heat of the materials drops due to the addition of a supercooling inhibitor and a thickening agent. Meanwhile, Patent Literature 2 describes use of two, higher and lower phase transition temperatures, but is silent about a supercooling inhibitor.

The present invention, in one aspect thereof, has been made in view of these problems and has an object to provide a thermal storage material with a reduced melting point that still freezes in a common refrigerator and also to provide a cold insulation container and refrigerator using such a thermal storage material.

### Solution to Problem

To achieve the object, the present invention is arranged as follows. The present invention, in an aspect thereof, is directed to a thermal storage material that changes phase at a prescribed temperature, the thermal storage material including: water, a base compound including a quaternary ammonium salt that forms a semi-clathrate hydrate; and potassium hydrogen carbonate, wherein the potassium hydrogen carbonate is saturated at an onset temperature of solidification.

### Advantageous Effects of Invention

The present invention, in some aspects thereof, restrains supercooling and enables solidification at a temperature higher than an aqueous solution of a base compound. The present invention, in some aspects thereof, can also reduce a melting point and maintain an object at a relatively low temperature.

### BRIEF DESCRIPTION OF DRAWINGS

FIG. 1A is an illustration of a sample of Example 1 being frozen.

FIG. 1B is an illustration of a sample of Comparative Example 1 being separated.

FIG. 2 is a diagram representing temperature changes of materials of Example 1 and Comparative Example 3 being melted after frozen in a compact thermostatic chamber whose temperature setting was adjusted to 3° C.

FIG. 3 is a graph representing a relationship between temperature and amounts of heat in Examples 1 to 3 and Comparative Examples 2 and 3.

FIG. 4 is a diagram representing temperature changes of materials of Example 4 and Comparative Example 5 being melted after frozen in a compact thermostatic chamber whose temperature setting was adjusted to 3° C.

FIG. 5 is a graph representing a relationship between temperature and amounts of heat in Example 4 and Comparative Examples 4 and 5.

FIG. 6 is a diagram representing results of XRD experiments.

FIG. 7 is a schematic illustration of a logistic packaging container of Example 9.

FIG. 8 is a schematic illustration of a logistic packaging container of Example 10.

FIG. 9 is a schematic illustration of a refrigerator of Example 11.

FIG. 10 is a schematic illustration of Example 12.

FIG. 11 is a schematic illustration of Example 12.

FIG. 12 is a diagram representing temperature changes of materials of Example 13 and Comparative Example 6 being melted after frozen in a compact thermostatic chamber whose temperature setting was adjusted to 5° C.

FIG. 13 is a graph representing a relationship between temperature and amounts of heat in Example 13 and Comparative Example 6.

### DESCRIPTION OF EMBODIMENTS

The following will give definition to some terms used in the present application. These terms should be interpreted in conformity with the following definitions unless otherwise mentioned explicitly.

(1) The terms, “clathrate hydrate” and “semi-clathrate hydrate,” are used interchangeably. The present invention is directed to hydrates encaging a non-gaseous species as a guest (guest compound).

(2) The terms, “thermal storage material” and “cold storage material,” are used interchangeably. Nevertheless, a material may be referred to as a cold storage material if the material has a melting point at or below 20° C., which is a standard condition, and may be referred to as a thermal storage material if the material has a melting point at or above 20° C.

(3) Thermal storage materials and cold storage materials, being practical implementations of the present invention, each contain thermal storage base compound (cold storage base compound), an alkalizing agent, and a nucleating agent in the present invention.

(4) The term, “thermal storage base compound (cold storage base compound),” refers to a composition, of water and a guest compound, that forms a semi-clathrate hydrate (as defined in (1) above) encaging a non-gaseous species as a guest. The thermal storage base compound (cold storage base compound) may be in the solid phase, in the liquid phase, or in a phase-changing state.

(5) The terms, “solidification temperature” and “freezing temperature,” both refer to a temperature at which a thermal storage material changes from the liquid phase to the solid phase. In the present invention, the solidification temperature, or the freezing temperature, is measured using a thermocouple while lowering the temperature of a cooling container (e.g., refrigerator, freezer, or programmable thermostatic chamber) housing a plastic bottle containing at least 50 mL of a thermal storage material. It is known that supercooling phenomena can vary depending on the volume of the thermal storage material. The inventors have confirmed through experiments that supercooling phenomena are hardly affected by the volume if the volume is greater than or equal to 50 mL.

(6) The onset temperature of melting is determined by extrapolating the temperature at which an exothermic peak starts toward a baseline on a differential scanning calorimetry (“DSC”) thermogram obtained by DSC.

(7) The terms, “frozen state” and “solidified state,” both refer to a state where the solid phase accounts for 95% or more of the total volume with the liquid phase, which is present in a tiny volume, being separated from the solid phase. The terms do not encompass a state where solid particles are suspended or dispersed in a liquid.

(8) Latent heat is calculated from the area of an exothermic peak on a DSC thermogram obtained by differential scanning calorimetry (DSC) and expressed as an amount of heat per weight or volume of the thermal storage material.

(9) In typical thermal storage tanks and transport media, solid particles of a clathrate encaging tetra-n-butylammonium bromide as a guest are often used in a dispersed or suspended state, or in the form of “slurry.” Most thermal storage materials used in the present embodiment change to solid, not a suspended state, at or below the phase transition temperature for the following reasons. The heat available from one gram of an aqueous solution in a slurry state is as little as 7 to 11 calories, which is too little for such an aqueous solution to be used as a thermal storage material. The thermal storage material does not need to be in a suspended state at or below the phase transition temperature unless the usage requires a fluid material. The thermal storage material turns into a slurry when tetra-n-butylammonium bromide has a sufficiently low concentration, for example, 20 wt % or lower.

The inventors of the present invention, focusing on the fact that no thermal storage materials containing tetrabutylammonium bromide (hereinafter, “TBAB”) have a relatively low melting point and still freeze in a refrigerator, have found that a mixture of water, a base compound including TBAB, and potassium hydrogen carbonate, when adjusted in a such manner that the potassium hydrogen carbonate can saturate at an onset temperature of solidification, can exhibit a melting point reduced by approximately 3° C. and freeze at 3° C., which has led to the present invention.

Accordingly, the present invention, in an aspect thereof, is directed to a thermal storage material including water, TBAB, and potassium hydrogen carbonate, wherein the potassium hydrogen carbonate is saturated at an onset temperature of solidification. The TBAB is present in a ratio of from 32 wt % to 40.5 wt %, both inclusive. When the TBAB is present in a ratio of 32 wt %, the potassium hydrogen carbonate is present in a ratio of 13 wt %. Meanwhile, when the TBAB is present in a ratio of 40.5 wt %, the potassium hydrogen carbonate is present in a ratio of 10 wt %.

The inventors have hence produced a TBAB-based thermal storage material that has a relatively low melting point and still freezes in a refrigerator. A specific description will be now given of embodiments of the present invention with reference to drawings.

### Composition of Thermal Storage Materials

A thermal storage material in accordance with the present invention changes phase at a prescribed temperature and contains water, a base compound, and potassium hydrogen carbonate. The base compound contains a quaternary ammonium salt and forms a semi-clathrate hydrate. This use of a base compound that forms a semi-clathrate hydrate renders large latent heat energy available for exploitation. The base compound is tetrabutylammonium bromide (TBAB).

It is conventionally known that the supercooling inhibitor in the liquid phase is generally dissolved and when cooled, solidifies (crystallizes) before the thermal storage material (base compound), thereby providing crystals serving as nuclei from which freezing starts. Solubility varies with temperature and decreases at low temperature, contributing to the freezing of the supercooling inhibitor.

### Method of Manufacturing Thermal Storage Materials

The thermal storage material may be manufactured by mixing water, a base compound (e.g., TBAB), and potassium hydrogen carbonate at room temperature. A suitable amount of each component is weighed out before being mixed.

### Clathrate Hydrate

Clathrate hydrates typically have a polyhedral crystal structure (cage or basket) formed by hydrogen-bonded water molecules such as a dodecahedral, tetrakaidecahedral, or hexakaidecahedral structure. Water molecules are hydrogen-bonded to each other to form a cavity and also to those water molecules forming another cavity, thereby forming a polyhedron. It is known that clathrate hydrates have crystal types called structure I and structure II.

Structure I has unit cells each formed of 46 water molecules, six large cavities (tetrakaidecahedra each of 12 five-membered rings and two six-membered rings), and two small cavities (tetrakaidecahedra each of five-membered rings). Meanwhile, structure II has unit cells each formed of 136 water molecules, eight large cavities (hexakaidecahedra each of 12 five-membered rings and four six-membered rings), and 16 small cavities (tetrakaidecahedra each of five-membered rings). These unit cells generally form a cubic crystal structure in clathrate hydrates encaging a gaseous species as a guest compound.

Meanwhile, when the guest compound is a large molecule of a non-gaseous species such as a quaternary ammonium salt used in the present invention, some hydrogen bonds forming a cage in the clathrate hydrate are broken, forming dangling bonds. Semi-clathrate hydrates encaging tetra-n-butylammonium bromide as a guest compound have two types of crystal structures: tetragonal and orthorhombic.

An orthorhombic unit cell has six dodecahedral cages, four tetrakaidecahedral cages, and four pentakaidecahedral cages and encages two tetra-n-butylammonium bromide molecules as guest compounds. Bromine atoms are integrated into the cage structure and bonded to water molecules. Tetra-n-butylammonium ions (cations) are enclathrated in the center of four cages (two tetrakaidecahedral and two pentakaidecahedral cages) having some dangling bonds. The six dodecahedral cages are hollow. A tetragonal unit cell is similarly structured of a combination of dodecahedral, tetrakaidecahedral, and pentakaidecahedral cages, with the dodecahedral cages being hollow.

These two types of crystal structures are now described using hydration numbers (molar ratios) of tetra-n-butylammonium bromide and water. Water molecules have an average hydration number of approximately 26 (molar ratio of 1:26) in the tetragonal type and approximately 36 (molar ratio of 1:36) in the orthorhombic type. The concentration of tetra-n-butylammonium bromide in this condition is termed a congruent melting point composition, which is approximately 40 wt/o in the tetragonal type and approximately 32 wt % in the orthorhombic type.

### Example 1 and Comparative Example 1

Two materials were prepared for comparison, by adding different types of carbonate ions to a 40.5 wt % solution of TBAB: one of them was potassium hydrogen carbonate (Example 1) and the other was potassium carbonate (Comparative Example 1).

In other words, in Example 1, the base compound of the thermal storage material was TBAB, and potassium hydrogen carbonate was added to a 40.5 wt % TBAB solution. The TBAB and the potassium hydrogen carbonate had a molar ratio of 1:1. A precipitate formed in the solution of Example 1. This solution had a pH of 9.1, an onset temperature of melting of 8.2° C. as measured by DSC, and a latent heat of 154 J/g as measured by DSC.

Meanwhile, in Comparative Example 1, the base compound of the thermal storage material was TBAB, and potassium carbonate was added to a 40.5 wt % TBAB solution. The TBAB and the potassium carbonate had a molar ratio of 1:1. Separation was observed in the solution of Comparative Example 1.

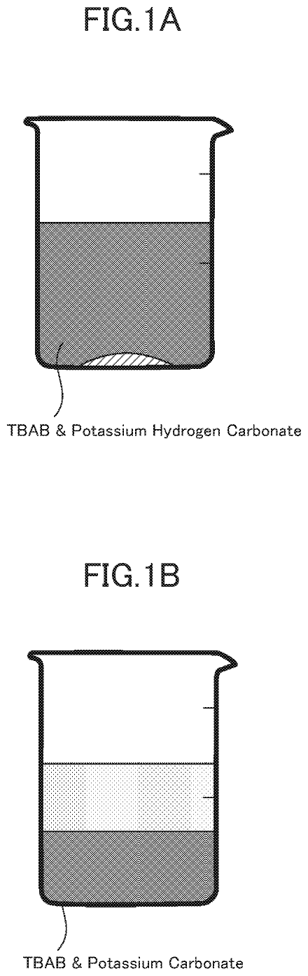

Next, the samples of Example 1 and Comparative Example 1 were placed in a compact thermostatic chamber whose temperature setting was adjusted to 3° C. The sample of Example 1 was observed to freeze in 18 hours as shown in FIG. 1A. In contrast, the sample of Comparative Example 1, although being placed in the compact thermostatic chamber for 18 hours, was observed to remain separated in a liquid state as shown in FIG. 1B.

The material of Example 1 freezes at 3° C. as demonstrated here and can be a component of a thermal storage material freezing in a common refrigerator.

Examples 1, 2, and 3 and Comparative Examples 2 and 3 In Example 2, the base compound of the thermal storage material was TBAB, and sodium hydrogen carbonate was added to a 40.5 wt % TBAB solution. The TBAB and the potassium hydrogen carbonate had a molar ratio of 1:0.5 No precipitate formed in this solution, with all the potassium hydrogen carbonate being dissolved. This solution had a pH of 9.1, an onset temperature of melting of 8.3° C. as measured by DSC, and a latent heat of 150 J/g as measured by DSC. The material did not freeze in a compact thermostatic chamber whose temperature setting was adjusted to 3° C., but froze in a freezer. The sample frozen in a freezer, under some conditions, produced a precipitate upon melting. Under such conditions, the sample froze in a compact thermostatic chamber whose temperature setting was adjusted to 3° C. Therefore, the sample needs to produce a precipitate to be able to freeze.

In Example 3, the base compound of the thermal storage material was TBAB, and sodium hydrogen carbonate was added to a 40.5 wt % TBAB solution. The TBAB and the potassium hydrogen carbonate had a molar ratio of 1:1.5. A precipitate formed in this solution. The solution had a pH of 9.2, an onset temperature of melting of 8.2° C. as measured by DSC, and a latent heat of 151 J/g as measured by DSC.

In Comparative Example 2, the base compound of the thermal storage material was TBAB. A 40.5 wt % TBAB solution was prepared. No other materials were added. This solution had a pH of 4.1, an onset temperature of melting of 11.9° C. as measured by DSC, and a latent heat of 191 J/g as measured by DSC.

In Comparative Example 3, the base compound of the thermal storage material was TBAB, and sodium tetraborate pentahydrate was added to a 40.5 wt % TBAB solution. The TBAB and the sodium tetraborate pentahydrate had a molar ratio of 1:0.055. A precipitate formed in this solution. The solution had a pH of 9.7, an onset temperature of melting of 10.5° C. as measured by DSC, and a latent heat of 159 J/g as measured by DSC.

These samples were placed in a compact thermostatic chamber whose temperature setting was adjusted to 3° C. in order to freeze them. The samples of Examples 1 and 3 and Comparative Example 3 were observed to freeze. Note that the samples of Examples 1 to 3 all froze in a freezer. A precipitate formed upon melting after freezing. The samples of Examples 1 to 3 were all observed to freeze at 3° C. if a precipitate formed in the samples.

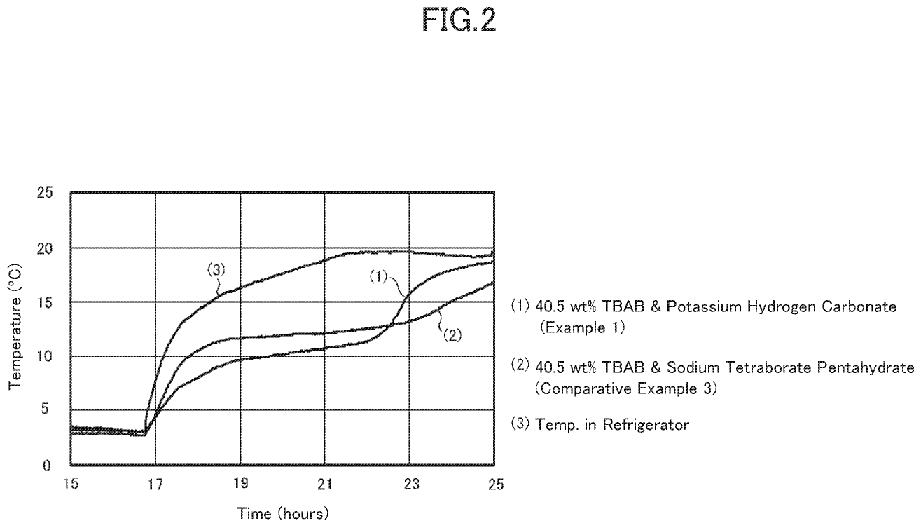

FIG. 2 is a diagram representing temperature changes of materials of Example 1 and Comparative Example 3 being melted after frozen in a compact thermostatic chamber whose temperature setting was adjusted to 3° C. These materials had different melting points, which were calculated from temperature change measurements through differentiation. Example 1 had a melting point of 9.9° C., whereas Comparative Example 3 had a melting point of 11.7° C. It is hence verified that the melting point fell in Example 1.

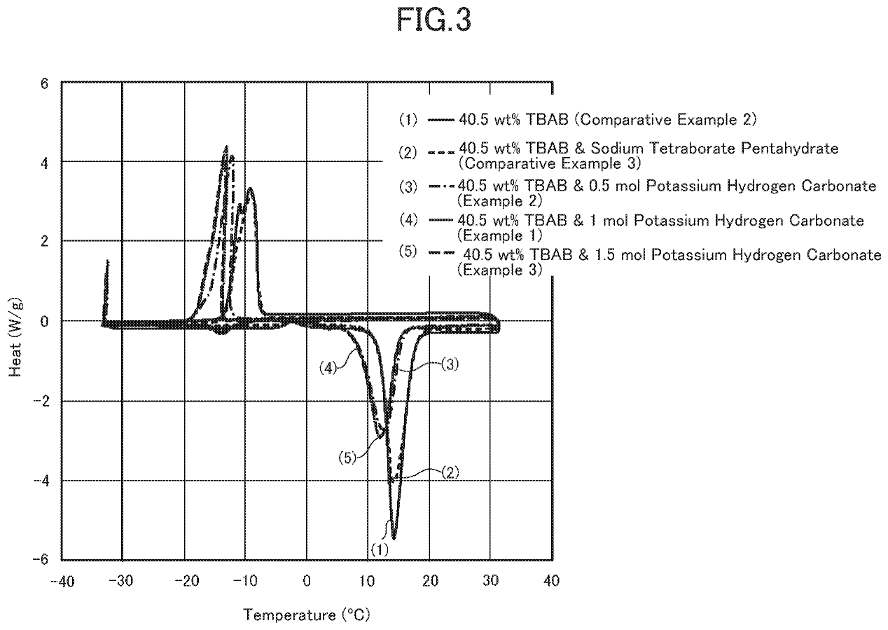

FIG. 3 is a graph representing a relationship between temperature and amounts of heat in Examples 1 to 3 and Comparative Examples 2 and 3. The melting point did not fall in Comparative Examples 2 and 3 as indicated by curves (1) and (2). In other words, the sample of Comparative Example 2 containing only TBAB and the sample of Comparative Example 3 containing TBAB and sodium tetraborate pentahydrate did not exhibit a reduced melting point. In contrast, the samples of Examples 1 to 3 containing potassium hydrogen carbonate all exhibited a melting point reduced by approximately 3° C. as indicated by curves (3), (4), and (5).

### Example 4 and Comparative Examples 4 and 5

In Example 4, the base compound of the thermal storage material was TBAB, and potassium hydrogen carbonate was added to a 32 wt % TBAB solution. The TBAB and the potassium hydrogen carbonate had a molar ratio of 1:1.3. A precipitate formed in this solution. The solution had a pH of 9.2, a first onset temperature of melting of 3.4° C. as measured by DSC, a second onset temperature of melting of 9.0° C. as measured by DSC, and a latent heat of 147 J/g as measured by DSC.

In Comparative Example 4, the base compound of the thermal storage material was TBAB. A 32 wt % TBAB solution was prepared. No other materials were added. This solution had a pH of 4.1, a first onset temperature of melting of 9.0° C. as measured by DSC, a second onset temperature of melting of 10.5° C. as measured by DSC, and a latent heat of 168 J/g as measured by DSC.

In Comparative Example 5, the base compound of the thermal storage material was TBAB, and sodium tetraborate pentahydrate was added to a 32 wt % TBAB solution. The TBAB and the sodium tetraborate pentahydrate had a molar ratio of 1:0.069. The thermal storage material was prepared by adding 0.8 grams of sodium tetraborate pentahydrate to 40 grams of a 32 wt % TBAB solution. A precipitate formed in this solution. The solution had a pH of 9.7, a first onset temperature of melting of 7.8° C. as measured by DSC, a second onset temperature of melting of 9.3° C. as measured by DSC, and a latent heat of 160 J/g as measured by DSC.

The sample of Comparative Example 4 was an aqueous TBAB solution with no supercooling inhibitor or other materials being added. Meanwhile, sodium tetraborate pentahydrate was added as a supercooling inhibitor in Comparative Example 5. These samples were placed in a compact thermostatic chamber whose temperature setting was adjusted to 3° C. in order to freeze them. The samples of Example 4 and Comparative Example 5 were observed to freeze.

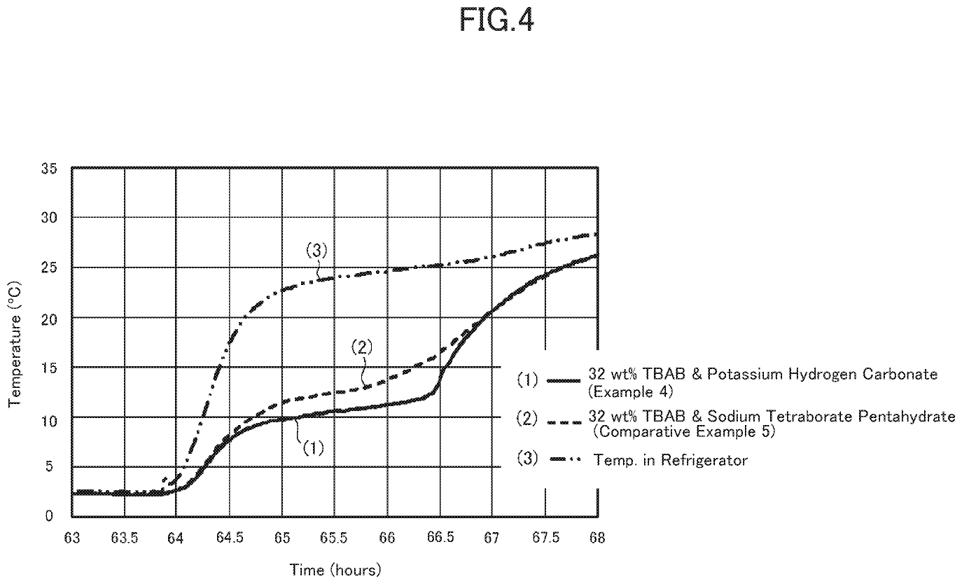

FIG. 4 is a diagram representing temperature changes of materials of Example 4 and Comparative Example 5 being melted after frozen in a compact thermostatic chamber whose temperature setting was adjusted to 3° C. These materials have different melting points. As mentioned earlier, the material of Example 4 had a first onset temperature of melting of 3.4° C. and a second onset temperature of melting of 9.0° C., both as measured by DSC. Meanwhile, the material of Comparative Example 5 had a first onset temperature of melting of 7.8° C. and a second onset temperature of melting of 9.3° C., both as measured by DSC. It is hence verified that the melting point fell more in Example 4 than in Comparative Example 5.

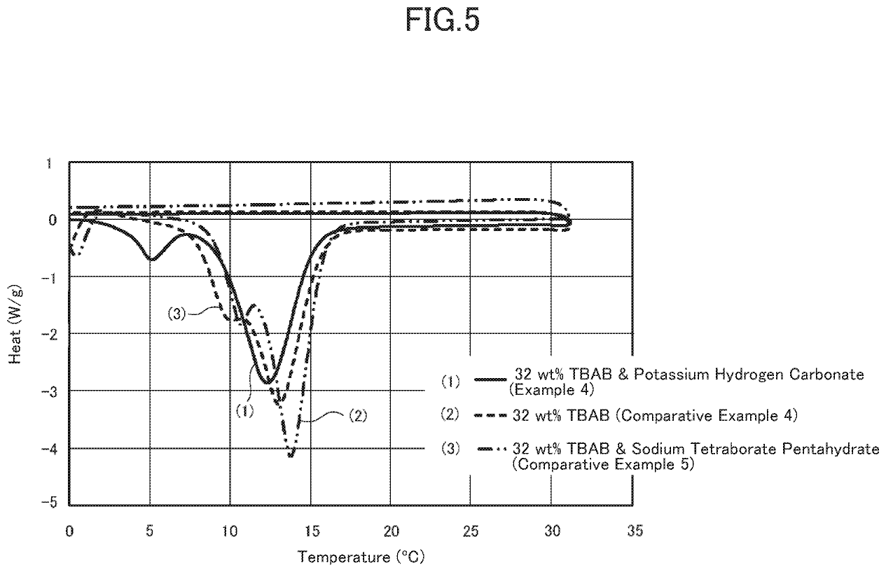

FIG. 5 is a graph representing a relationship between temperature and amounts of heat in Example 4 and Comparative Examples 4 and 5. Comparative Example 4 did not exhibit a reduced melting point as indicated by curve (2) because no materials were added to the 32 wt % TBAB solution. The melting point fell in both Example 4 and Comparative Example 5 as indicated by curves (1) and (3), falling more in Example 4 than in Comparative Example 5.

### Example 6

Saturation concentration was checked in Example 6. Potassium hydrogen carbonate was added to a 32 wt % TBAB solution and a 40 wt % TBAB solution, and these solutions were observed to find out the concentration at which the added potassium hydrogen carbonate started to remain undissolved. It was observed that potassium hydrogen carbonate started to remain undissolved in a 32 wt % TBAB solution at least at room temperature (25° C.) when potassium hydrogen carbonate was added up to 13% in terms of effective concentration. It was also observed that potassium hydrogen carbonate started to remain undissolved in a 40 wt % TBAB solution at least at room temperature (25° C.) when potassium hydrogen carbonate was added up to 10%.

### Example 7

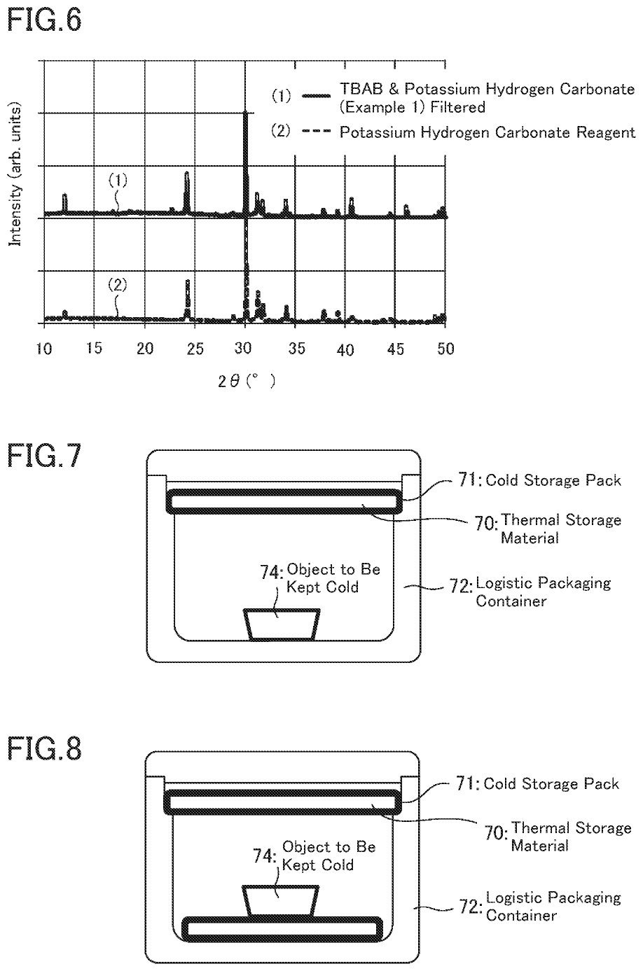

A precipitate was analyzed in Example 7. The solution of Example 1 was filtered to collect the precipitate in order to identify the deposit produced in the sample. This sample was subjected to powder XRD. Potassium hydrogen carbonate was also subjected to XRD for comparison purposes. FIG. 6 is a diagram representing results of these XRD experiments. Comparison of the results shows that the precipitate was potassium hydrogen carbonate.

### Example 8

Freezing experiments were done again in Example 8. Specifically, the solution filtered in Example 7, which no longer contained a precipitate, was placed in a compact thermostatic chamber whose temperature setting was adjusted to 3° C. The solution was observed to freeze in 18 hours. This result shows that there was some potassium hydrogen carbonate dissolved in the filtrate. The dissolved potassium hydrogen carbonate deposited at the solidification temperature, thereby forming nuclei and freezing.

### Examples 9, 10, and 11

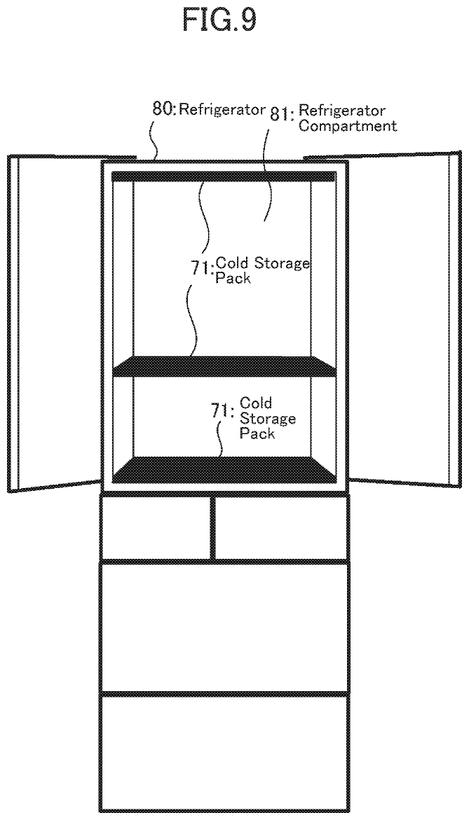

Example 9, 10, and 11 concern examples where a thermal storage material in accordance with the present embodiment is applied to cold insulation containers and refrigerators. FIG. 7 is a schematic illustration of a logistic packaging container of Example 9. FIG. 8 is a schematic illustration of a logistic packaging container of Example 10. FIG. 9 is a schematic illustration of a refrigerator of Example 11. Referring to FIGS. 7 and 8, a cold storage pack 71 filled with a thermal storage material 70 of any of Examples 1 to 8 is placed in a logistic packaging container 72, with the thermal storage material 70 being solidified. The cold storage pack 71 is disposed near the opening (not on the bottom side) of the logistic packaging container 72 in Example 9 shown in FIG. 7. This arrangement enables cold air to be fed from above to below an object 74 that is to be kept cold. Meanwhile, in Example 10 shown in FIG. 8, another cold storage pack 71 is disposed under the object 74 as well as near the opening of the logistic packaging container 72. This arrangement achieves improved cooling effects.

In these arrangements, as the logistic packaging container 72 comes into contact with open air during the delivery of the object 74, the internal temperature of the logistic packaging container 72 rises, and the thermal storage material(s) 70 consequently melt(s). The thermal storage material(s) 70 hence absorb(s) heat and maintain(s) the object 74 at or below 15° C.

The logistic packaging container 72 is preferably made of a thermally insulating material that prevents the internal temperature from rising, such as styrene foam or a vacuum insulation material. The cold storage pack 71 may be made of a resin material such as polyethylene, polypropylene, polyester, polyurethane, polycarbonate, polyvinyl chloride, or polyamide, a metal such as aluminum, stainless steel, copper, or silver, or an inorganic material such as glass or ceramics. The cold storage pack 71 is preferably made of a resin material for its durability and ease in forming a hollow structure. The cold storage pack 71 preferably has attached thereto a temperature-indicating, thermochromic sticker, so that a user can know the phase of the thermal storage material.

In Example 11, three cold storage packs 71 filled with a thermal storage material 70 of any of Examples 1 to 8 are disposed in different locations inside a refrigerator compartment 81 of a refrigerator 80. This arrangement enables the thermal storage material to solidify in commonly used refrigerators. Being capable of reducing the melting point, the thermal storage material 70 melts at a lower temperature than does an aqueous solution of only TBAB with no other materials being added. These features enable such temperature control as to maintain an object at a relatively low temperature.

### Example 12

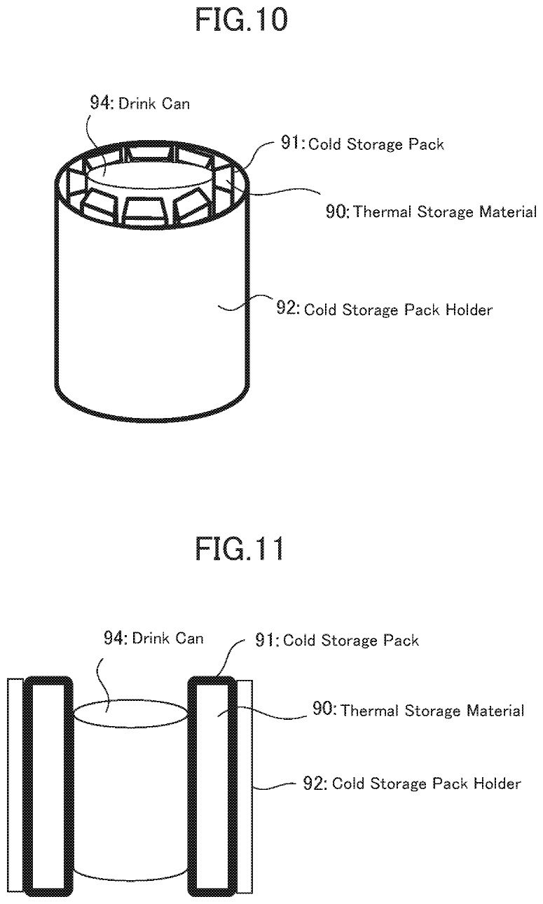

Example 12 concerns an example where a thermal storage material in accordance with the present embodiment is applied to cooling of a drink can. FIGS. 10 and 11 are schematic illustrations of Example 12. Referring to FIGS. 10 and 11, a cold storage pack 91 filled with a thermal storage material 90 is held in a cold storage pack holder 92 to cool a drink can 94 in Example 12. Specifically, the cold storage pack 91 is brought into contact with the drink can 94 by using the cold storage pack holder 92, with the thermal storage material 90 being solidified. The thermal storage material 90 rises in temperature and melts from the heat of the drink can 94. The thermal storage material 90 hence absorbs heat and hence rapidly cools the drink can 94.

A plurality of cold storage packs 91 is brought into contact with around the drink can 94 by using the cold storage pack holder 92. This arrangement enables efficient absorption of heat from the drink can 94.

The cold storage pack 91 is preferably made of a film-shaped material that is easily brought into intimate contact with the drink can 94 such as polyethylene, polyester, polyvinyl alcohol, polypropylene, nylon, polycarbonate, or polyvinyl chloride. A thermochromic substance may, in the form of a sticker, be attached to the surface of the cold storage pack 91 or may be kneaded into a film that is a component of the cold storage pack 91, so that the user can visually recognize the temperature of the cold storage pack 91. This arrangement renders rapid cooling effects visible.

The cold storage pack holder 92 is preferably made of a thermally insulating material that prevents heat from being exchanged with open air, such as polyethylene foam, urethane foam, or glass wool. The drink can 94 may be an aluminum can, a steel can, or any other can for drinks and may contain a water-based beverage. Example 12 enables rapid cooling of the drink can 94.

The base compound has been TBAB in the examples of the invention described above. The examples described below concern thermal storage materials, containing tetrabutylammonium fluoride (hereinafter, “TBAF”) as a base compound, that have a relatively low melting point and still freeze in a refrigerator.

### Example 13 and Comparative Example 6

In Comparative Example 6, the base compound of the thermal storage material was TBAF. A 33 wt % TBAF solution was prepared. No other materials were added. This solution had an onset temperature of melting of 27.1° C. and a latent heat of 220 J/g, both as measured by DSC.

In Example 13, the base compound of the thermal storage material was TBAF, and sodium hydrogen carbonate was added to a 33 wt % TBAF solution. The TBAB and the potassium hydrogen carbonate had a molar ratio of 1:1.5. A precipitate formed in this solution. The solution had an onset temperature of melting of 21.1° C. and a latent heat of 176 J/g, both as measured by DSC.

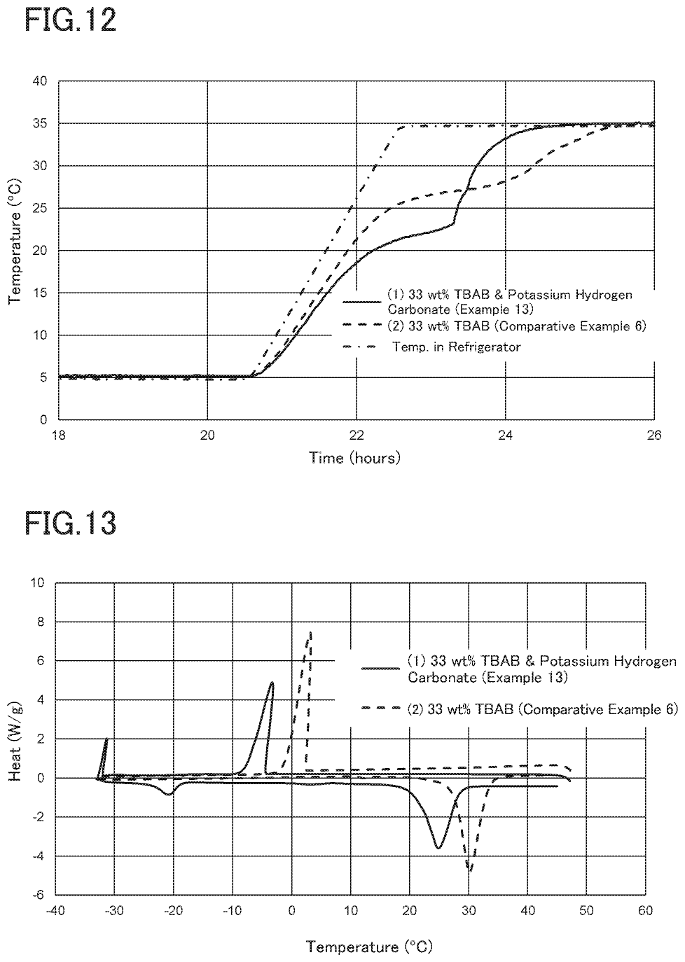

FIG. 12 is a diagram representing temperature changes of materials of Example 13 and Comparative Example 6 being melted after frozen in a compact thermostatic chamber whose temperature setting was adjusted to 5° C. The materials of Example 13 and Comparative Example 6 were both observed to freeze, but had different melting points: 21° C. for Example 13 and 27° C. for Comparative Example 6.

FIG. 13 is a graph representing a relationship between temperature and amounts of heat in Example 13 and Comparative Example 6. The melting point did not fall in Comparative Example 6 as indicated by curve (2) because no materials were added to the 33 wt % TBAF solution. The melting point fell in Example 13 as indicated by curve (1).

(A) The present invention may have the following aspects. The present invention, in an aspect thereof, is directed to a thermal storage material that changes phase at a prescribed temperature, the thermal storage material including: water; a base compound including a quaternary ammonium salt that forms a semi-clathrate hydrate; and potassium hydrogen carbonate, wherein the potassium hydrogen carbonate is saturated at an onset temperature of solidification.

This arrangement restrains supercooling and enables solidification at a temperature higher than an aqueous solution of the base compound. The arrangement can also reduce the melting point and enables such temperature control as to maintain an object at a relatively low temperature. Conventionally, the concentration of the base compound has been reduced to lower the melting point. Reducing the base compound concentration, however, results in a higher water concentration. Even when a supercooling inhibitor is added, the influence of the water is so large that reducing solidification temperature is inevitable. Another problem is lower latent heat that results from the lower base compound concentration. The present invention, in an aspect thereof, can reduce the melting point by approximately 3° C. and maintain sufficiently high latent heat, without having to reduce the base compound concentration.

(B) The thermal storage material solidifies at 3° C. and melts at a temperature lower than a melting point of an aqueous solution of at least only the base compound.

In this arrangement, the thermal storage material solidifies at 3° C. and therefore can be solidified in commonly used refrigerators. The thermal storage material has a reduced melting point and therefore melts at a temperature lower than the aqueous solution of only the base compound. The arrangement hence enables such temperature control as to maintain an object at a relatively low temperature.

(C) The base compound is either tetrabutylammonium bromide or tetrabutylammonium fluoride.

This arrangement can maintain sufficiently high latent heat, restrain supercooling, and enables solidification at a temperature higher than an aqueous solution of the base compound. The arrangement can also reduce the melting point and enables such temperature control as to maintain an object at a relatively low temperature.

(D) When the base compound is tetrabutylammonium bromide, the tetrabutylammonium bromide is present in a ratio of from 32 wt % to 40.5 wt %, both inclusive.

This arrangement can maintain sufficiently high latent heat, restrain supercooling, and enables solidification at a temperature higher than an aqueous solution of the base compound. The arrangement can also reduce the melting point and enables such temperature control as to maintain an object at a relatively low temperature.

(E) When the tetrabutylammonium bromide is present in a ratio of 32 wt %, the potassium hydrogen carbonate is present in a ratio of 13 wt %.

This arrangement allows for such an increased concentration of potassium hydrogen carbonate that potassium hydrogen carbonate can remain undissolved at 25° C. The arrangement can hence achieve sufficient supercooling inhibiting effects and also maintain sufficiently high latent heat.

(F) When the tetrabutylammonium bromide is present in a ratio of 40.5 wt %, the potassium hydrogen carbonate is present in a ratio of 10 wt %.

This arrangement allows for such an increased concentration of potassium hydrogen carbonate that potassium hydrogen carbonate can remain undissolved at 25° C. The arrangement can hence achieve sufficient supercooling inhibiting effects and also maintain sufficiently high latent heat.

(G) The thermal storage material according to claim 3, wherein the base compound is tetrabutylammonium fluoride, and when the tetrabutylammonium fluoride is present in a ratio of 33 wt %, the potassium hydrogen carbonate is present in a ratio of 12 wt %.

This arrangement allows for such an increased concentration of potassium hydrogen carbonate that potassium hydrogen carbonate can remain undissolved at 25° C. The arrangement can hence achieve sufficient supercooling inhibiting effects and also maintain sufficiently high latent heat.

(H) The present invention, in an aspect thereof, is directed to a cold insulation container including: a housing section configured to accommodate an object to be kept cold; and a cold storage pack disposed inside the housing section, the cold storage pack containing the thermal storage material of any one of aspects (A) to (E) above, wherein the thermal storage material exchanges heat with the object in the housing section.

In this arrangement, the thermal storage material can be solidified in commonly used refrigerators. The thermal storage material has a reduced melting point and therefore melts at a temperature lower than the aqueous solution of only the base compound. The arrangement hence enables such temperature control as to maintain an object at a relatively low temperature.

(H) The present invention, in an aspect thereof, is directed to a refrigerator including: a refrigerator compartment configured to accommodate an object to be kept cold; and the thermal storage material of any one of aspects (A) to (E)5 above inside the refrigerator compartment, wherein the thermal storage material exchanges heat with the object in the refrigerator compartment.

In this arrangement, the thermal storage material can be solidified in commonly used refrigerators. The thermal storage material has a reduced melting point and therefore melts at a temperature lower than the aqueous solution of only the base compound. The arrangement hence enables such temperature control as to maintain an object at a relatively low temperature.

The present invention, in some aspects thereof, is applicable to thermal storage materials with a reduced melting point that still freeze in a common refrigerator and also to cold insulation containers, refrigerators, and other like apparatus using such a thermal storage material.

1. A thermal storage material that changes phase at a prescribed temperature, the thermal storage material comprising:
water;
a base compound including a quaternary ammonium salt that forms a semi-clathrate hydrate; and
potassium hydrogen carbonate,
wherein the potassium hydrogen carbonate is saturated at an onset temperature of solidification.

2. The thermal storage material according to claim 1, wherein the thermal storage material solidifies at 3° C. and melts at a temperature lower than a melting point of an aqueous solution of at least only the base compound.

3. The thermal storage material according to claim 1, wherein the base compound is either tetrabutylammonium bromide or tetrabutylammonium fluoride.

4. The thermal storage material according to claim 1, wherein
the base compound is tetrabutylammonium bromide, and
the tetrabutylammonium bromide is present in a ratio of from 32 wt % to 40.5 wt %, both inclusive.

5. The thermal storage material according to claim 4, wherein when the tetrabutylammonium bromide is present in a ratio of 32 wt %, the potassium hydrogen carbonate is present in a ratio of 13 wt %.

6. The thermal storage material according to claim 4, wherein when the tetrabutylammonium bromide is present in a ratio of 40.5 wt %, the potassium hydrogen carbonate is present in a ratio of 10 wt %.

7. The thermal storage material according to claim 1, wherein
the base compound is tetrabutylammonium fluoride, and
when the tetrabutylammonium fluoride is present in a ratio of 33 wt %, the potassium hydrogen carbonate is present in a ratio of 12 wt %.

8. A cold insulation container comprising:
a housing section configured to accommodate an object to be kept cold; and
a cold storage pack disposed inside the housing section, the cold storage pack containing the thermal storage material according to claim 1, wherein
the thermal storage material exchanges heat with the object in the housing section.

9. A refrigerator comprising:
a refrigerator compartment configured to accommodate an object to be kept cold; and
the thermal storage material according to claim 1 inside the refrigerator compartment, wherein
the thermal storage material exchanges heat with the object in the refrigerator compartment.
